(19) United States
(12) Patent Application Publication
(10) Pub. No.: US 2010/0066679 A1
(43) Pub. Date: Mar. 18, 2010

(54) POWER SAVING APPARATUS AND METHOD FOR WIRELESS MOUSE

(75) Inventor: CHIEN-CHOU PAN, Hsinchu (TW)

Correspondence Address: WPAT, PC;INTELLECTUAL PROPERTY ATTORNEYS, 7225 BEVERLY ST., ANNANDALE, VA, 22003, US

(73) Assignee: HOLTEK SEMICONDUCTOR INC., Hsinchu (TW)

(21) Appl. No.: 12/250,901

(22) Filed: Oct. 14, 2008

(30) Foreign Application Priority Data
Sep. 12, 2008 (TW) 097134977

(51) Int. Cl. G06F 3/02

(52) U.S. Cl. 345/166

(57) ABSTRACT

The invention mainly relates to a mouse with a capacitive tact switch incorporated thereto. When the user touches the mouse, the capacitive tact switch in the mouse will sense the proximity and inform the host control circuit immediately. Contrarily, when the user's hand is leaving the mouse, the capacitive tact switch will inform the host control circuit to shut down completely the most power consuming parts such as RF module, CMOS sensor thereby the goal of power saving can be achieved.

### BACKGROUND OF THE INVENTION

1. Field of the invention

The present invention relates to a wireless mouse characterized in power saving, more particularly to, a wireless mouse with power saving characteristics and is incorporated with a capacitive tact switch thereto.

2. Description of the Prior Arts

The conventional wireless mouse can enter a power saving mode in the idle state, which is acting periodically in a very high frequency so as to make the user cannot feel the delay.

When the mouse is taken away from the pad or the table, the LED in the mouse starts scintillating which means that said wireless mouse is searching for the feedback signals, and the scintillation is periodical. For the consideration of avoiding continuously consuming power, when the user has not used the mouse for a predetermined period of time, the mouse enters a sleep mode. However, in order to reduce the response delay, at this moment, the mouse will turn off the system power and enter the so-called sleep mode. And for some mouse a move detection to activate the power is applied by the same theory, however, the LED and the CMOS sensor are activated for every 0.1 second in the sleep mode. In the sleep mode, said LED and said CMOS sensor still consume 30 uA at least.

Accordingly, a person skilled in the art can take advantage of the power saving method disclosed in U.S. Pat. No. 7,228,102 B2. The disclosure of said prior art mainly relates to the proximity of the mouse by human body can affect the capacitive value of the RF antenna inside the mouse and further change the resonant point of the antenna. While the resonant point is shifted, the voltage value sensed by the voltage detection device will be changed accordingly so as to achieve the goal of detecting if the user detects the mouse.

However, the drawbacks for the prior art are: 1) RF circuit needs to be maintained operating, and as long as the operation is maintained for RF circuit, a low power consumption can not be achieved. 2) The approach disclosed in the prior art is suffering from the EMC interference. 3) There exist some certain difficulties in the mass production.

There is a demand for a wireless optical mouse, which can be incorporated a tact switch, said tact switch available on market can be categorized by the follows: 1) According to the theory: a resistor type, a capacitive type, an optical type, and surface voice wave type . . . etc. 2) According to the function: a digital type or an analog type. No matter digital or analog, based on its theory, it is the most popular and power saving for the capacitive type.

Accordingly, in view of the above drawbacks, it is an imperative that a power saving wireless optical mouse, especially the same with capacitive tact switch thereto is designed so as to solve the drawback such that the conventional mouse cannot simultaneously shut down its RF module and its optical sensor module.

### SUMMARY OF THE INVENTION

In view of the disadvantages of prior art, the primary object of the present invention relates to a wireless optical mouse, which takes advantage of the capacitive tact switch to achieve the goal of power saving.

Preferably, said wireless mouse comprises:

an optical sensor module; a power module; a capacitive sensing device, a capacitive tact switch, coupled to said capacitive sensing device; a RF module; and a host control circuit, wherein when capacitance or variation of the capacitance of said capacitive sensing device exceeds a predetermined value, said capacitive tact switch informs said host control circuit to enter a operation mode and turns on said optical sensing module and RF module; if contrary, then the host control circuit enters a sleep mode and fully shuts down said optical sensing module and said RF module.

The present invention further relates to control method of power saving in a wireless mouse, said wireless mouse including a capacitive sensing switch, a host control circuit, and a power module, said method comprises the steps of the follows:

(a) the capacitance or the variation of the capacitance of said capacitive sensing device exceeds a predetermined value? If no, said host control circuit keeps on working in a sleep mode; if yes, go to the next step;

(b) said host control circuit turns on said power module;

(c) said host control circuit is operating in the operation mode;

(d) the capacitance or the variation of the capacitance of said capacitive sensing device exceeds a predetermined value? If yes, said host control circuit keeps on working in a operation mode; if no, go to the next step;

(e) confirming if the user does not use the mouse, if no, goes to (c); if yes, go to the next step;

(f) entering the power saving mode, and shutting down the power module; and

(g) said host control circuit operating in the sleep mode, entering (a).

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become readily understood from the detailed description given herein below and the accompanying drawings which are given by way of illustration only, and thus are not limitative of the present invention and wherein:

FIG. 1 relates to a circuit diagram of a preferred embodiment according to the present invention; and

FIG. 2 relates to a flow chart according to FIG. 1 of the present invention.

### DESCRIPTION OF THE EXEMPLARY EMBODIMENTS

The following descriptions are of exemplary embodiments only, and are not intended to limit the scope, applicability, or configuration of the invention in any way. Rather, the following description provides a convenient illustration for implementing exemplary embodiments of the invention. Various changes to the described embodiments may be made in the function and arrangement of the elements described. For your esteemed members of reviewing committee to further understand and recognize the fulfilled functions and structural characteristics of the invention, several exemplary embodiments cooperating with detailed description are presented as the follows.

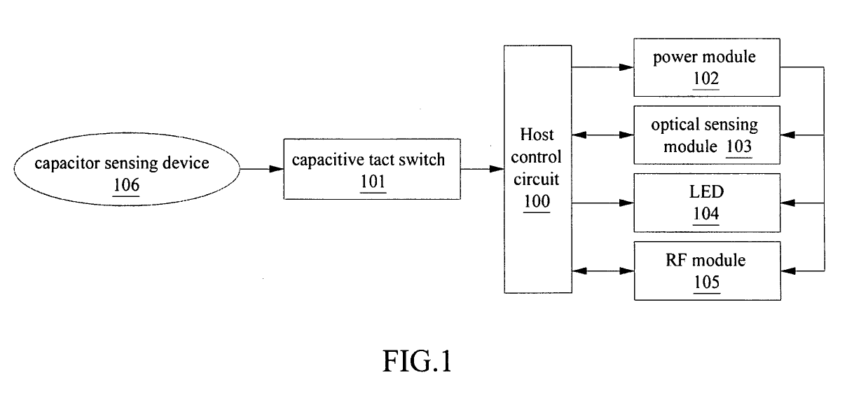

FIG. 1 relates to a diagram of the preferred embodiment of the present invention.

As depicted in FIG. 1, which is a wireless mouse characterized in power saving, comprises: a LED 104; a power module 102; a capacitor sensing device 106; a capacitive tact switch 101, coupled to said device 106; an optical sensor module 103; a RF module 105; and a host control circuit 100.

The circuit depicted in FIG. 1 is operated according to the steps as follows:

1) When the system in FIG. 1 operates in an operating mode, the host control circuit periodically detects the proximity of the user via said device 106 and said switch 101 (Namely, to see if said 106 detects the capacitance or the variation of the capacitance is exceeding a predetermined value), and if the proximity of the user is detected, then the system remains in the operating mode, meanwhile, said host control circuit 100, LED 104, said optical module 103 and RF module 105 function normally.

2) When the system is in the operation mode, if said host control circuit 100 detects the proximity of the user being away from the mouse via said device 106 and said switch 101, (Namely, to see if said 106 detect the capacitance or the variation of the capacitance is below a predetermined value), said host control circuit 100 starts the confirming procedure, which confirms the user is leaving the mouse. Said host control circuit 100 turns off a power module supply peripheral circuit 202 via a control circuit 201, and turns off the peripheral circuits such as said LED 104, said optical module 103, and RF module 105 to achieve the goal of power saving. At this moment, the system enters a power saving mode.

3) When the system enters a power saving mode, only said switch 101 and said device 106 keep on working (Namely, for each time interval said device 106 checks if said 106 detect the capacitance or the variation of the capacitance is exceeding a predetermined value), said host control circuit 100 enters a sleep mode, and the rest circuits such as LED 104, said module 103, and said RF module are turned off.

4) When the system enters the power saving mode, the host control circuit 100 enters the sleeping mode. For each time interval, said switch 101 and said device 106 periodically check if the user touches the mouse, once if the proximity of the user to a mouse is detected (if said 106 detect the capacitance or the variation of the capacitance is exceeding a predetermined value), said switch 101 wakes up said circuit 100 via control circuit 200, and as soon as said host control circuit 100 was waken up, said power module 102 is turned on via said control circuit 201, and the system enters a operation mode, meanwhile, said LED 104, said optical module 103, and said RF module 105 resume their operation.

Preferably, said switch 100 can be a chip made of RC oscillation approach. When an external object such as human finger approaches, the capacitance in said RC oscillation and the frequency of RC oscillation change. Meanwhile, said switch 100 can also be a chip made of capacitance charging approach. When an external object such as human finger approaches, the voltage charging duration is changed. Their advantage for the design is no external components needed and the corresponding design is simple.

Preferably, said mouse further comprises a battery to supply electricity to the mouse. And said battery can be an ordinary one or a charging one. And said charging battery can be further coupled to the solar cell installed on the top of the mouse and said solar cell is electrically chargeable.

Preferably, said capacitor sensing device 106 on said mouse can be a metal stripe or metal conductor.

Preferably, said switch 101 and said host control circuit 100 are integrated on a single chip.

Preferably, said host control circuit 100 is programmable.

Preferably, said switch 101 is digital typed or analog typed.

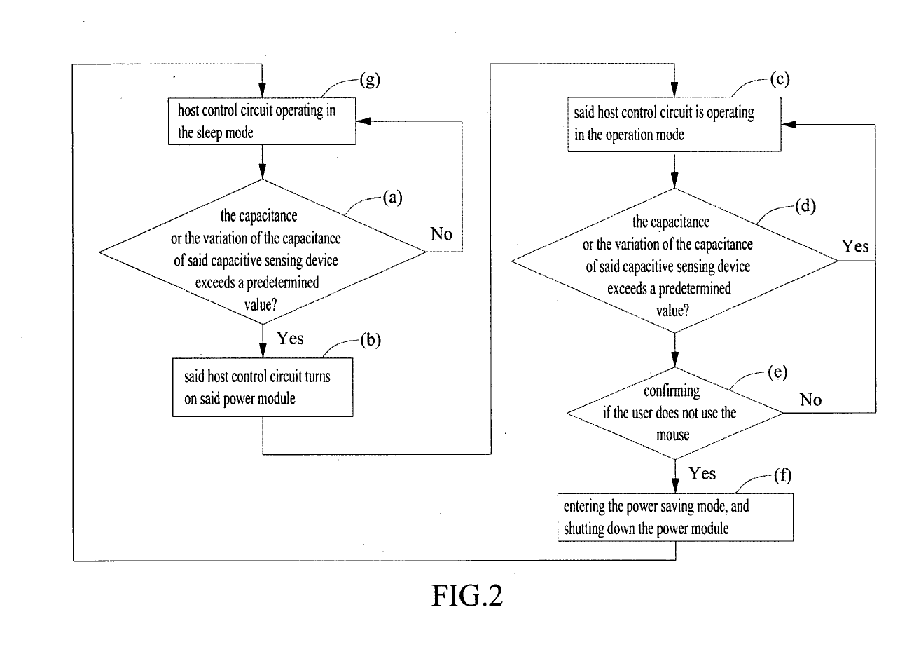

The operational flow chart of FIG. 1 is depicted in FIG. 2, and the default for the host control circuit is working at the sleeping mode, which comprises:
(a) the capacitance or the variation of the capacitance of said capacitive sensing device exceeds a predetermined value? If no, said host control circuit keeps on working in a sleep mode; if yes, go to the next step;
(b) said host control circuit turns on said power module;
(c) said host control circuit is operating in the operation mode;
(d) the capacitance or the variation of the capacitance of said capacitive sensing device exceeds a predetermined value? If yes, said host control circuit keeps on working in a operation mode; if no, go to the next step;
(e) confirming if the user does not use the mouse, if no, goes to (c); if yes, go to the next step;
(f) entering the power saving mode, and shutting down the power module; and
said host control circuit operating in the sleep mode, entering (a).

The invention being thus aforesaid, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A wireless mouse characterized by power saving, comprising:
an optical sensor module;
a power module;
a capacitive sensing device;
a capacitive tact switch, coupled to said capacitive sensing device;
a RF module; and
a host control circuit, wherein when capacitance or variation of the capacitance of said capacitive sensing device exceeds a predetermined value, said capacitive tact switch informs said host control circuit to enter an operation mode and turns on said optical sensing module and RF module; if contrary, then the host control circuit enters a sleep mode and fully shuts down said optical sensing module and said RF module.

2. The wireless mouse as set forth in claim 1, wherein said optical sensor module further comprising a LED.

3. The wireless mouse as set forth in claim 1, further comprising a battery, for providing the electricity to said host control circuit.

4. The wireless mouse as set forth in claim 1, wherein said capacitive sensing device is selected from the group of a metal strip or a metal conductor.

5. The wireless mouse as set forth in claim 1, wherein said capacitive tact switch and said host control circuit are integrated on a single chip.

6. The wireless mouse as set forth in claim 1, wherein said host control circuit is programmable.

7. The wireless mouse as set forth in claim 1, wherein said capacitive tact switch is digital typed.

8. The wireless mouse as set forth in claim 1, wherein said capacitive tact switch is analog typed.

9. The wireless mouse as set forth in claim 1, wherein for each time interval said host control circuit checks if said capacitive sensing device or said capacitive tact switch detect the capacitance to be exceeding a predetermined value.

10. The wireless mouse as set forth in claim 1, wherein for each time interval said host control circuit checks if said capacitive sensing device or said capacitive tact switch detect the capacitance variation to be exceeding a predetermined value.

11. The wireless mouse as set forth in claim 1, wherein said capacitive tact switch is a chip made of RC oscillation approach.

12. The wireless mouse as set forth in claim 1, wherein said capacitive tact switch is a chip made of capacitance charging approach.

13. The wireless mouse as set forth in claim 1, further comprising a solar cell.

14. The wireless mouse as set forth in claim 3, wherein said battery is selected from the group of a charging battery or an ordinary battery.

15. The wireless mouse as set forth in claim 13, wherein said solar cell is electrically chargeable.

16. A power saving control method for a wireless mouse, said wireless mouse including a capacitive sensing switch, a host control circuit, and a power module, said method comprises the steps of the follows:
(a) the capacitance or the variation of the capacitance of said capacitive sensing device exceeds a predetermined value? If no, said host control circuit keeps on working in a sleep mode; if yes, go to the next step;
(b) said host control circuit turns on said power module;
(c) said host control circuit is operating in the operation mode;
(d) the capacitance or the variation of the capacitance of said capacitive sensing device exceeds a predetermined value? If yes, said host control circuit keeps on working in a operation mode; if no, go to the next step;
(e) confirming if the user does not use the mouse, if no, goes to (c); if yes, go to the next step;
(f) entering the power saving mode, and shutting down the power module; and
(g) said host control circuit operating in the sleep mode, entering (a).
